(19) United States
(12) Patent Application Publication
(10) Pub. No.: US 2015/0310421 A1
(43) Pub. Date: Oct. 29, 2015

(54) Electronic payment transactions without POS terminals

(71) Applicant: RFCyber Corporation, Fremont, CA (US)

(72) Inventors: Xiangzhen Xie, Shenzhen (CN); Hsin Pan, Fremont (CA)

(21) Appl. No.: 14/694,993

(22) Filed: Apr. 23, 2015

Related U.S. Application Data
(60) Provisional application No. 61/983,410, filed on Apr. 23, 2014.

(51) Int. Cl. G06Q 20/32; G06Q 20/40; G06Q 20/10

(52) U.S. Cl. CPC G06Q 20/3278; G06Q 20/10; G06Q 20/401; G06Q 20/3226

(57) ABSTRACT

Techniques for completing a financial transaction without deploying merchant POS are described. According to one aspect of the present invention, a user or buyer uses his/her smartphone to complete a monetary transaction with a seller, where the seller does not have a POS device instead receives a conformation from a designated party that a payment from the buyer has been received. A platform is described to support such transactions.

### BACKGROUND OF THE INVENTION

### Field of the Invention

The present invention is generally related to the area of electronic commerce. Particularly, the present invention is related to an electronic payment transaction without requiring a seller to have a POS-like device, which is particularly useful for at least two types of merchants including small brick and mortar merchants without an in-store Point of Sale (POS) system and Internet/web merchants.

With the proliferation of smart phones, many small merchants and patrons are expected to carry their smart phones everywhere and anytime. Currently, all the smart phones have camera features to read QR codes. With more and more Near Field Communication (NFC) phones coming to the markets, people are essentially equipped with contactless Integrated Circuit Card (ICC) (also commonly referred as smart card) reading capabilities anywhere and anytime. In addition, many of these phones have one or more secure elements (SE). An SE is another name for smart cards (e.g., external existing device such as SD or USB dongle).

The present disclosure teaches a method, an apparatus, a system, and/or a platform for completing a financial transaction without deploying merchant POS.

### SUMMARY OF THE INVENTION

This section is for the purpose of summarizing some aspects of the present invention and to briefly introduce some preferred embodiments. Simplifications or omissions may be made to avoid obscuring the purpose of the section. Such simplifications or omissions are not intended to limit the scope of the present invention.

The present invention is related to techniques for completing a financial transaction without deploying merchant POS. According to one aspect of the present invention, a user or buyer uses his/her smartphone to complete a monetary transaction with a seller, where the seller does not have a POS device instead receives a conformation from a designated party that a payment from the buyer has been received. A platform is described to support such transactions.

According to another aspect of the present invention, the payment platform allows the merchants to accept electronic payments (e.g., IC-based payments) with e-purse, credit and debit applications. According to yet another aspect of the present invention, the electronic payment is made successfully based on an identifier (ID) of a merchant obtained via a smartphone associated with the user, where the ID may be presented in a merchant tag (e.g., RFID) or in a one-dimensional or two-dimensional barcode (e.g., QR code).

The present invention may be implemented as a method or process, a single device, a server, a system or a part of system. It is believed that various implementations may lead to results that may not be achieved conventionally. According to one embodiment, the present invention is a method for facilitating a payment transaction without point-of-sale (POS) terminals, the method comprisses: issuing a merchant an identifying pack, the identifying pack including at least an identifier of the merchant; receiving in a server the identifying pack from a mobile device associated with a user desired to make a payment to the merchant, wherein the identifying pack is obtained by the user using the mobile device to read off the identifying pack from a medium; and sending from the server a confirmation message to a device associated with the merchant to indicate that the payment to the merchant is successfully performed.

According to another embodiment, the present invention is a mobile device for facilitating a payment transaction without point-of-sale (POS) terminals, the module device comprises: a memory space for storing a module; a processor, coupled to the memory space to execute the module to cause the mobile device to perform operations of: obtaining an identifying pack of a merchant when a user is ready to make a payment to the merchant; establishing a secure link with a server to send in the identifying pack, wherein the server is configured to confirm that the identifying pack is authenticated; determining how to make the payment in accordance with a display on the mobile device; receiving a confirmation that the payment goes through after the server performs the payment to the merchant, wherein the merchant is not required to have one of the POS terminals and receives only a conformation message from the server that the payment has been received.

Other objects, features, and advantages of the present invention will become apparent upon examining the following detailed description of an embodiment thereof, taken in conjunction with the attached drawings.

### BRIEF DESCRIPTION OF THE DRAWINGS

The invention will be readily understood by the following detailed description in conjunction with the accompanying drawings, wherein like reference numerals designate like structural elements, and in which:

FIG. 1A shows an exemplary configuration according to one embodiment of the resent invention;

FIG. 1B illustrates an internal functional block diagram of a computing device that may be used in FIG. 1A;

FIG. 2 shows data flows among different entities according to one embodiment; and

FIG. 3A and FIG. 3B show respectively two exemplary deployment platforms, one for online and the other for offline.

### DETAILED DESCRIPTION OF THE INVENTION

In the following description, numerous specific details are set forth to provide a thorough understanding of the present invention. The present invention may be practiced without these specific details. The description and representation herein are the means used by those experienced or skilled in the art to effectively convey the substance of their work to others skilled in the art. In other instances, well-known methods, procedures, components, and circuitry have not been described in detail since they are already well understood and to avoid unnecessarily obscuring aspects of the present invention.

Reference herein to “one embodiment” or “an embodiment” means that a particular feature, structure, or characteristic described in connection with the embodiment can be included in at least one implementation of the invention. The appearances of the phrase “in one embodiment” or “in the embodiment” in various places in the specification are not necessarily all referring to the same embodiment, nor are separate or alternative embodiments mutually exclusive of other embodiments. Further, the order of blocks in process, flowcharts or functional diagrams representing one or more embodiments do not inherently indicate any particular order nor imply limitations in the invention. As used in this specification and the appended claims, the singular forms “a,” “an,” and “the” include plural referents unless the context clearly dictates otherwise. It should also be noted that the term “or” is generally employed in its sense including “and/or” unless the context clearly dictates otherwise.

The present invention pertains to a platform and an application each of which is designed to allow a buyer and a seller to conduct a payment transaction electronically. As used herein, any pronoun references to gender (e.g., he, him, she, her, etc.) are meant to be gender-neutral. Unless otherwise explicitly stated, the use of the pronoun “he”, “his” or “him” hereinafter is only for administrative clarity and convenience. Additionally, any use of the singular or to the plural shall also be construed to refer to the plural or to the singular, respectively, as warranted by the context.

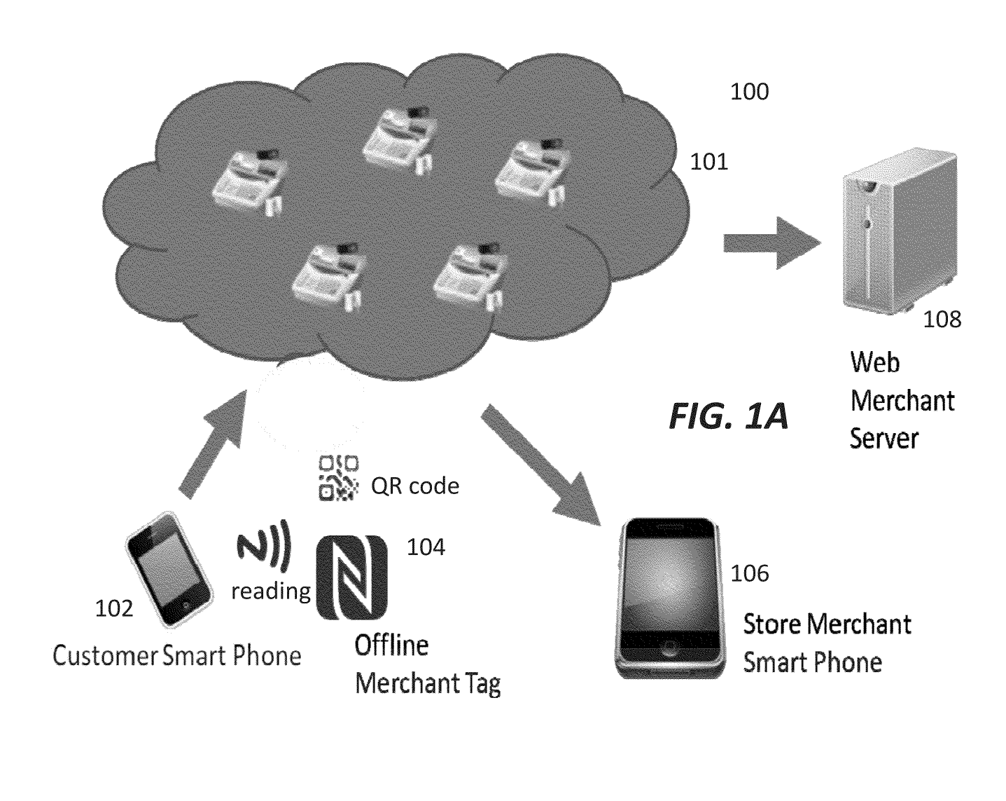

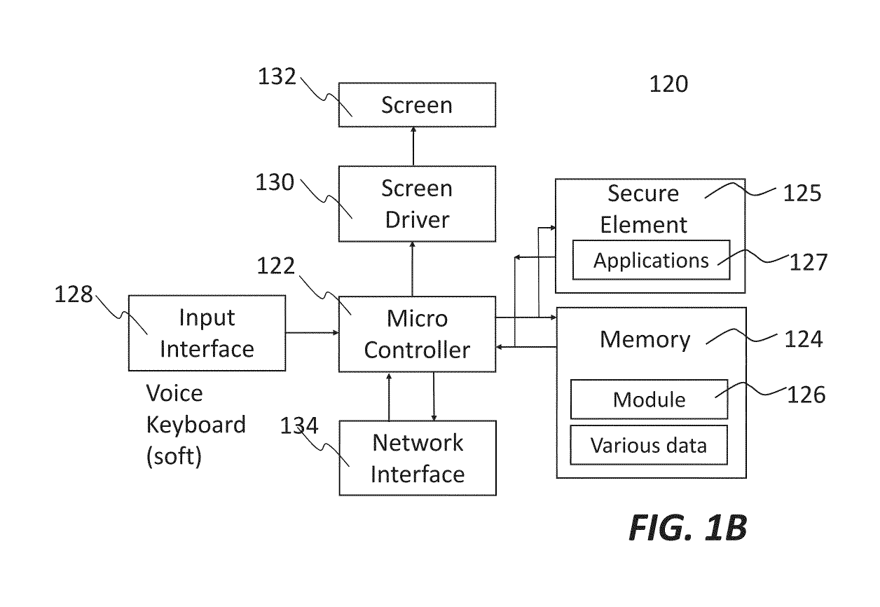

Embodiments of the present invention are discussed herein with reference to FIGS. 1A-3B. However, those skilled in the art will readily appreciate that the detailed description given herein with respect to these figures is for explanatory purposes only as the invention extends beyond these limited embodiments.

Smart cards offer many benefits to consumers, merchants and banks, such as an ability to store information and improved security through fraud reduction technology. A smart card, or integrated circuit (IC) card, is a pocket-sized card with embedded integrated circuits that can process information. Smart cards are far more versatile than traditional magnetic stripe cards, due to their ability to store transaction information and add/deduct value accordingly. Smart cards that combine transportation ticketing with payment applications in convenience stores, supermarkets, fast-food restaurants, parking services, vending machines and other point-of-sale applications are becoming increasingly popular worldwide. In China the advantages of these multi-purpose cards are also proving to be popular with over 80 cities reportedly using smart cards for a varying number of applications. In cities such as Hong Kong, Beijing, Shanghai and Shenzhen, multi-functional smart cards are not only used for transportation, but also for payment of electricity, gas and water bills. Commonly, a smart card is operable with a point of sale (POS) terminal.

As the use of smartphones is becoming popular, instead of providing individual physical smart cards, the smart cards are being implemented together or within a smartphone. Unless specifically stated, a card herein means a function being provided by or in a smartphone that can be used as a smartcard.

EMV, which stands for Europay, MasterCard and Visa is a global standard for inter-operation of integrated circuit cards (IC cards or “chip cards”) and IC card capable point of sale (POS) terminals and automated teller machines (ATMs), for authenticating credit and debit card transactions. EMV is a joint effort initially conceived by Europay. MasterCard and Visa to ensure the security and global interoperability of chip-based payment cards. Besides EMV, there is also a PBOC standard. It is a Chinese technical and security standard for smart cards, which applies to both contact and non-contact smart cards. This standard is also known as the ‘Chinese EMV’ and is broadly similar to the EMV standard. However, the introduction of this separate standard still requires that electronic payments have to be made with a POS terminal.

One of the important features, advantages and objects of the present invention is to provide a payment platform without requiring a POS terminal. FIG. 1A shows an exemplary configuration 100 according to one embodiment of the resent invention. There are four components in the platform of FIG. 1, all coupled to a network 101. An example of the network 101 includes, but my not be limited to, a wireless or/and wired network, the Internet or/and intranet. As a representative, each of the four components is the following:
Customer smart phone 102 to make a payment;
Merchant smart phone 104 to receive a payment notification after the payment from the customer smart phone 102 is approved;
For offline stores, merchant information stored in a media 106 (which can be accessed by a customer smart phone via contactless approach), such as an NFC Tag, a QR code, a Bluetooth device, a sound, an infrared source, a wireless source and iBeacon source; and
Backend servers 108 to implement physical POS device functionalities

User registration: the mobile device 102 is configured as a personal payment terminal associated with a user. The terminal 102 is configured to access one or more authorized cards therein. In operation, a user first downloads an application or module from a distributor. The distributor may be a service provider, an application store (e.g., an Apple Store or Google Play). To enable the module to make payments, the user needs to perform the following steps:
first to register the identity of the device with a server operated by a service provider (e.g., Rich House Global Technology, Inc., hereinafter RHG, located at High Tech Park North, Nanshang District, Shenzhen, China). The module is configured to read the International Mobile Equipment Identity (IMEI) of the mobile phone and register it with a backend server.
to allow the module to register the number of the mobile phone with the server.
to allow the module to access payment modules or applications installed on one or more secure elements (SE), if they exist. In one embodiment, one or more payment applications are installed on both the software and hardware secure element (SE) of the device 102. The software SE is, for example, Host Card Emulation (HCE). The hardware SE can be an embedded SE or a SWP SIM of that device. It shall be noted that the installed module is not responsible to install and personalize these payment applications. These applications should have been personalized by the user with the respective issuing entities (such as an issuing bank). The details of the installation and personalization of a software module or application are provided in co-pending U.S. application Ser. No. 11/739,044 that is hereby incorporated by reference.
To register each payment application on an SE (or each of secure elements). The installed module is configured to access the Payment System Environment (PSE) on the SE to retrieve the payment application installed on the SE. If the SE supports the PSE, the terminal reads out the necessary information to select the Application Data File (ADF). If there is no PSE, the terminal uses a list of well known application IDs by using a SELECT apdu to select the installed payment application on the SE. For the payment application on the SE, the installed module is configured to allow a user to assign a name thereto. For instance: ABC Bank debit, ABC Bank ECash and XYZ VISA Credit so that the user may choose one of the named methods to make a payment. The installed module is configured to store the payment options locally and/or on the server for later use when making a payment transaction.

After the registration, the installed module is able to use a payment option until
the payment application associated with the option is expired or disallowed by the corresponding issuing entity.
The device is suspended either involuntary by the backend server after it is detected that it has had some abnormal activities or voluntarily by the request of the user.

According to one embodiment, a user uses an external smart card in which case the mobile device 102 can function as a reader to read the external IC card. In operation, the user has to register the external IC card. The registration includes the user to present a payment card to the module to read via an NFC interface of the mobile device. Similar to registering the payment options on the internal SE, the module is now configured to register the payment application on each external IC card. The module stores the payment options and the identifiers of the external IC cards at the backend server. If there are more than one payment options authorized on a mobile device (both internal and external cards), the user can set a default payment option.

Referring now to FIG. 1 B, it illustrates an internal functional block diagram 120 of a computing device that may be used in FIG. 1A. The computing device 120 corresponding to the mobile device 102 of FIG. 1A and includes a microprocessor or microcontroller 122, a memory space 124 in which there is an module 126, a secure element (SE) 125, an input interface, a screen driver 130 to drive a display screen 132 and a network interface 134. The module 126 is a software version representing one embodiment of the present invention, and downloadable over a network from a library (e.g., Apple Store) or a designated server (e.g., the server 108 of FIG. 1A).

It shall be noted that a secure element (SE) is a tamper-resistant platform (e.g., a single-chip secure microcontroller) capable of securely hosting applications and their confidential and cryptographic data (e.g., key management) in accordance with the rules and security requirements set forth by a set of well-identified trusted authorities. The common form factors of SE include: Universal Integrated Circuit Card (UICC), embedded SE and microSD. Both the UICC and microSD are removable. In one embodiment of the invention, a software module is configured to act as an SE and upgradable by overwriting some or all of the components therein. Regardless of the form factors, each form factor links to a different business implementation and satisfies a different market need. To have the SE function as needed, the SE shall have been personalized. The details of personalizing an SE are described in co-pending U.S. application Ser. No. 13/749,696 which is hereby incorporated by reference.

The input interface 128 includes one or more input mechanisms. A user may use an input mechanism to interact with the device 120 by entering a command to the microcontroller 122. Examples of the input mechanisms include a microphone or mic to receive an audio command and a keyboard (e.g., a displayed soft keyboard) to receive a texture command. Another example of an input mechanism is a camera provided to capture a photo or video, where the data for the photo or video is stored in the device for immediate or subsequent use with the module 126. Optionally, as part of the input interface 128, the computing device 120 is equipped with an NFC capability to read off a tag nearby.

The driver 130, coupled to the microcontroller 122, is provided to take instructions therefrom to drive the display screen 132. In one embodiment, the driver 130 is caused to drive the display screen 132 to display a list of payment methods to allow a user thereof to choose one for payment. The network interface 134 is provided to allow the device 120 to communicate with other devices via a designated medium (e.g., a data network).

According to one implementation, the module 126 is loaded in the memory 124 and executed by the controller or microprocessor 122 for the user to access an installed payment application 127 that has already provisioned with a secure element in the computing device 120. The module 126 is configured to allow the user to make a payment via the server 108 without requiring the merchant to have a POS terminal.

There is no specific requirement for a terminal used by a merchant, although the computing device 120 may be used by a merchant to receive a payment message from a designated server to confirm that the payment from a user or buyer has been received.

Merchant registration: the server 108 is configured to sign up merchants and register the merchants in its backend database. According to one embodiment, the merchant information includes:
a merchant identifier (ID) issued by the service provider;
a number of outlets and their locations and/or a corresponding outlet ID;
acceptable payment methods, depending on the merchant, the payment methods generally include credit card, debit card or e-purse; and
a merchant type, merchant bank information etc that are needed by a clearance network.

Each merchant is issued an identifying pack for a user to read. The identifying pack allows the server to recognize the merchant. Depending on implementation, the identifying pack may be an NFC Tag, a QR code, a Bluetooth device or a sound, and can be read off via wireless means (e.g., infrared or Bluetooth). The typical information embedded in such an identifying pack includes:
the merchant ID;
the merchant name;
the outlet ID to identify an outlet of the merchant; and
a digital digest.

The information on the identifying pack (e.g., a tag) is protected by the digital digest that is signed using a private key provided by the server 108 when the device 102 establishes a secured link with the server 108. The digest is used by the payment application on the terminal 102 to prove the authenticity of the tag. The payment application uses the corresponding public key certificate to recover the plain text of the digest and to compare against the result of the digest calculation.

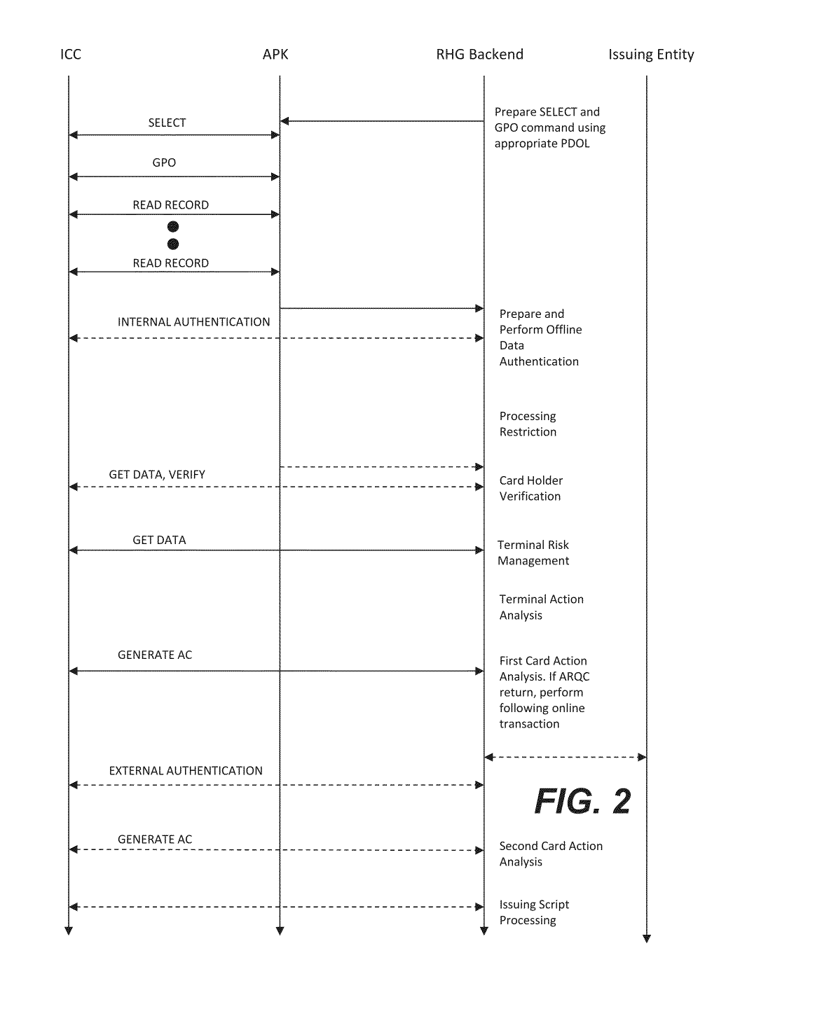

Referring now to FIG. 2, it shows data flows among different entities according to one embodiment. As shown in FIG. 2, there are four entities: ICC 202, an APK 204, a RHG Backend 206 and an issuing entity 208. To facilitate the understanding of FIG. 2, ICC 202 corresponds to a payment option registered with the smart phone 102. In general, ICC 202 may be an external or internal IC card, related to a credit card or e-purse in the smart phone 102. APK 204 standing for Android application package corresponds to the installed module (e.g., 126 of FIG. 1B), RHG Backend 206 corresponds to the merchant server 108. Issuing entity 208 is a business issuing or supporting one of the payment options.

It is assumed that a transaction flow per FIG. 2 for checkout is at a brick and mortar store, which means that the merchant does not have a POS terminal. A customer carries a smart phone with camera or/and NFC capabilities. The customer buys goods or a service and is ready to check out with the merchant. In operation, the customer uses his smart phone either to touch the merchant NFC tag and to launch the installed module (a.k.a., APK 204) on his smart phone to read an QR code.

In either case, the APK is configured to show merchant info on the customer phone. If the APK is allowed to access the location-based information of the customer (it is well-known that most of the smart phones are able to detect the location thereof), the APK contacts the RHG backend 206 for verification of the merchant. The current GPS location is used to match the registered offline merchant store in the NFC Tag, an indicator will show on RHG Payment APK to indicate a match is verified.

The customer is allowed to pull down from the backend merchant information including a list of accepted payment methods for the registered merchant. The backend server determines a list of acceptable payment options based on the payment options available on the registered payment options and applications of the customers and the option acceptable by the merchant. The Customer can then proceed with the default payment method if the method is acceptable by the merchant. Otherwise, the customer can select an acceptable payment method offered by the merchant. In one embodiment, an payment option accessible by the RFC Payment APK is grayed out if it is not acceptable by the merchant.

Upon selecting a payment method, the customer enters the payment amount and shows the screen to the merchant. After the customer touches a button to initiate the payment, the APK shall prompts the customer to place the card for reading if the selected payment application is on an external ICC. Otherwise, the APK simply transacts against the installed payment application on the SE. The APK will first send the device identity, the payment type, payment application information, the merchant ID and payment amount to the RHG merchant POS server.

After verifying the payment option is acceptable by the merchant, the backend server prepares the SELECT apdu and the GET PROCESSING OPTIONS with appropriate Processing Options Data Object List (PDOL) according to the merchant acquiring bank information. The APK is configured to select the application on the transacted SE and issue the GET PROCESSING OPTIONS to initiate a transaction against the payment application. Based on the Application File Locator (AFL) in the GPO response, the APK shall issue a sequence of READ RECORD commands to retrieve the records from the application. This information is then sent to the backend server to inform the server of this new transaction.

The subsequent processing between the application and the POS backend is substantially similar as the payment card is presented to a physical POS in a retail store, except that the APK acts as a proxy on the mobile device for relaying the APDU commands and responses between the backend server and the selected payment application.

Operationally, the backend server is configured to conduct Offline data authentication using either Static Data Authentication (SDA), Dynamic Data Authentication (DDA) or Combined Data Authentication (CDA) based on the capability of the payment application. According to one embodiment of the present invention, CDA is always the preferred choice unless the ICC application does not support it. The backend server is configured to perform terminal risk management and terminal action analysis to preliminarily decide whether the transaction should be conducted online or offline.

Based on the outcome, the backend server prepares the GENERATE APPLICATION CRYPTOGRAM apdu to ask for one of the following cryptograms from the application:
Transaction certificate (TC)—Offline approval
Authorization Request Cryptogram (ARQC)—Online authorization
Application Authentication Cryptogram (AAC)—Offline decline.

After analyzing the data, the application can accept the suggested action, decline a transaction or force the transaction on-line. If CDA is selected, the application is configured to compute a dynamic signature to be included in the response. Upon receiving the response, the backend server is configured to verify this signature before any further action. The verification ensures the authenticity and integrity of the response. If the ARQC is received by the backend server in the first GENERATE AC response, the backend server will send the ARRC to the issuer.

The ARQC is a digital signature of the transaction details, which can be checked in real time by the issuing entity. The issuer responds to an authorization request with a response code, an authorization response cryptogram (ARPC) and optionally an issuer script (a string of commands to be sent to the application).

If the response message from the issuer contain the Issuer Authentication Data and the Application Interchange Profile indicates that the ICC supports issuer authentication, the Issuer Authentication Data shall be sent to the application in the EXTERNAL AUTHENTICATE command. The second GENERATE AC will be sent to the application to generate the TC or AAC. Similarly, the backend server will first verify the response of this second Generate AC command if CDA is used.

During the transaction, a PIN may be requested from user to identify the cardholder. If the transaction has successfully completed, customer's RHG Payment APK will show that the payment is done and the merchant's RHG Merchant APK will be triggered and showed payment received. The backend server performs settlement of the transactions similar to the traditional financial clearance of payment transactions.

Web Merchant Flow: a customer checks out at an online store and chooses to pay using the payment method described herein. The customer is asked to provide his mobile phone number or other identifier (e.g., email address, or driver license number). The merchant backend invokes the RHG Payment API to request RHG to collect the payment. The request includes the merchant ID, the payment amount and the mobile phone number. RHG then notifies the customer via its registered mobile payment terminal. The customer opens the APK and the payment request is shown on the screen. The information includes the merchant's details and the payment amount. The payment flow is substantially similar to most of the offline transactions described above. After the payment is accepted, RHG will inform the merchant of the payment. The merchant will continue its existing checkout process with customers.

Backend Server: A RHG backend server or system includes at least two major operations that may be housed in a single server or several servers, they represent at least a merchant server 108 in FIG. 1 and a POS server herein. The merchant server 108 is to handle merchant information and to act as a proxy to talk to RHG POS server or other bank POS server. It prepares message format for sending to the POS server. The POS server is to handle POS operations. Upon receiving a request from a mobile device, the merchant server accesses the merchant database for the merchant information and passes the information to the POS server.

In one embodiment, the POS server supports two operation modes: online and offline mode. It should be noted that the HSM includes the credential needed for the POS server to conduct offline card verification (such as SDA and DDA and CDA computation).

Online Mode: in the case that a RHG POS server does not have a sufficient permission to authorize a transaction, the POS server needs to operate in online mode to get the authorization from the issuing entity. Based on the merchant information, collected card information and card responses, the server can prepare messages according to the required designated format, these messages are then forwarded to the issuing entity directly. The RHG backend will treat the transaction as an “on-line” transaction against the issuing entity.

Offline Mode: in the case that both the POS and application agreeing on offline transaction, the transaction is handled by the RHG POS server using the credential of the respective issuing entity for that application. As a result, the transaction is done simply between the application and the RHG backend server. The RHG backend treats this transaction as ‘offline” transactions.

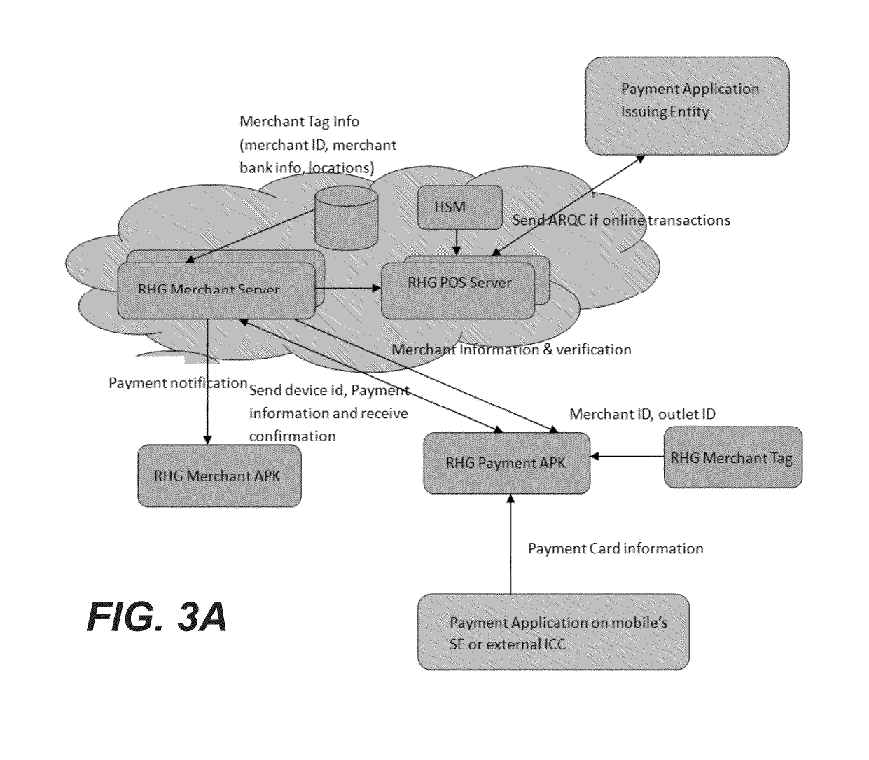

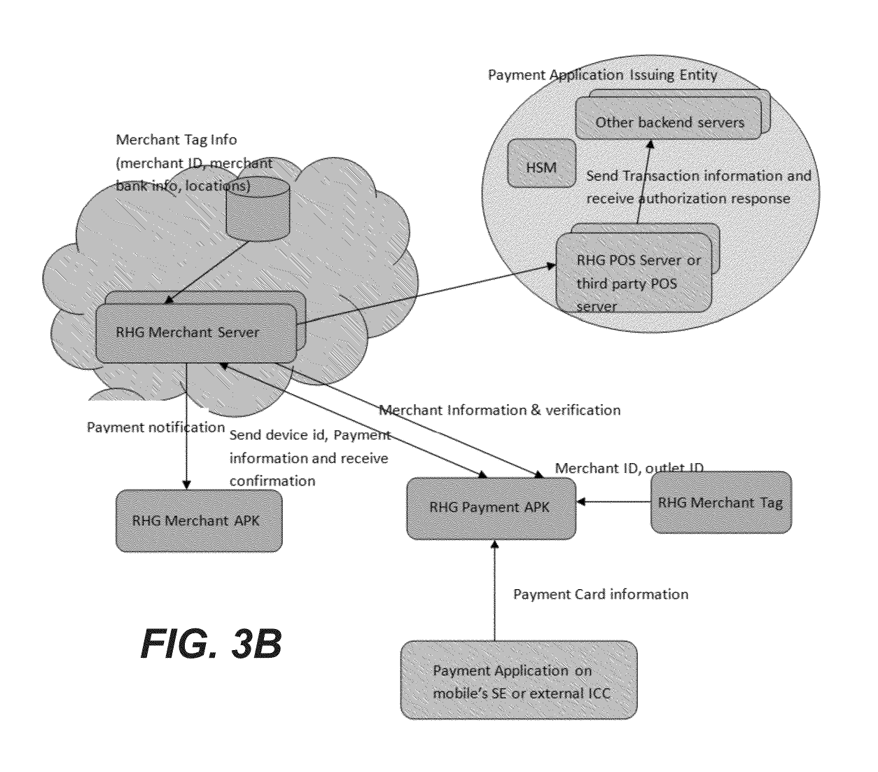

Alternate Deployment: For the issuing entity, a possible deployment between the issuing entity and the RHG server is that the entity runs the POS server with the merchant server hosted by RHG. In this deployment, the RHG backend server has no POS functionality for the issuing entity. It has only merchant information. It acts as a proxy for the POS deployed in the premises of that entity. FIG. 3A and FIG. 3B show respectively two exemplary deployment platforms, one for online and the other for offline.

The invention is preferably implemented in software, but can also be implemented in hardware or a combination of hardware and software. The invention can also be embodied as computer readable code on a computer readable medium. The computer readable medium is any data storage device that can store data which can thereafter be read by a computer system. Examples of the computer readable medium include read-only memory, random-access memory, CD-ROMs, DVDs, magnetic tape, optical data storage devices, and carrier waves. The computer readable medium can also be distributed over network-coupled computer systems so that the computer readable code is stored and executed in a distributed fashion.

The present invention has been described in sufficient details with a certain degree of particularity. It is understood to those skilled in the art that the present disclosure of embodiments has been made by way of examples only and that numerous changes in the arrangement and combination of parts may be resorted without departing from the spirit and scope of the invention as claimed. Accordingly, the scope of the present invention is defined by the appended claims rather than the foregoing description of embodiments.

We claim:

1. A method for facilitating a payment transaction without point-of-sale (POS) terminals, the method comprising:
issuing a merchant an identifying pack, the identifying pack including at least an identifier of the merchant;
receiving in a server the identifying pack from a computing device associated with a user desired to make a payment to the merchant, wherein the identifying pack is obtained by the user using the computing device to obtain the identifying pack from a medium; and
sending from the server a confirmation message to a device associated with the merchant to indicate that the payment to the merchant is successfully performed.

2. The method as recited in claim 1, wherein the identifying pack further includes a digital digest, and the method further comprising:
establishing a secure link between the server and the computing device to receive the identifying pack; and
extracting the digital digest from the received identifying pack to determine whether the identifying pack is authenticated.

3. The method as recited in claim 2, further comprising:
causing the computing device to show a list of payment methods available to the user after the server is configured to determine what payment methods are acceptable to the merchant and corresponding merchant bank information needed by a payment clearance network
wherein the list is established when the user registers the computing device with the server;
accepting a selection from the user among the available payment methods; and
performing the payment to the merchant.

4. The method as recited in claim 2, the identifying pack further includes a number of outlets the merchant has, corresponding locations of the outlets, and/or a corresponding outlet identifier.

5. The method as recited in claim 1, wherein the medium is one or more of a tag, a printed code, a Bluetooth device, a sound, an infrared source, a wireless source and iBeacon source.

6. The method as recited in claim 5, wherein the medium is either disposed near a checkout or offered electronically when the merchant is conducting business online.

7. The method as recited in claim 5, wherein the tag is read off by an Near Field Communication (NFC) interface of the computing device.

8. The method as recited in claim 5, wherein the printed code is read off by a camera of the computing device.

9. The method as recited in claim 8, wherein the printed code is a one-dimensional or two-dimensional barcode.

10. The method as recited in claim 1, wherein the computing device is installed with a module that is caused to register the computing device with the server.

11. The method as recited in claim 10, wherein the module installed in the computing device is configured to access payment applications installed with one or more secure elements in the computing device, wherein each of the payment applications has been provisioned with an issuing entity.

12. The method as recited in claim 1, wherein the user and the merchant are conducting a transaction over a data network, said receiving in a server the identifying pack from a computing device comprises:
determining the identifying pack is indeed from the computing device installed with a module authorized by the server, wherein the module is configured to read either a payment application provisioned with a secure element of the computing device or an external smart card.

13. A mobile device for facilitating a payment transaction without point-of-sale (POS) terminals, the module device comprising:
a memory space for storing a module;
a processor, coupled to the memory space to execute the module to cause the mobile device to perform operations of:
obtaining an identifying pack of a merchant when a user is ready to make a payment to the merchant;
establishing a secure link with a server to send in the identifying pack, wherein the server is configured to confirm that the identifying pack is authenticated;
determining how to make the payment in accordance with a display on the mobile device;
receiving a confirmation that the payment goes through after the server performs the payment to the merchant, wherein the merchant is not required to have one of the POS terminals and receives only a conformation message from the server that the payment has been received.

14. The mobile device as recited in claim 13, wherein the identifying pack further includes a digital digest, and the server extracts the digital digest from the received identifying pack to compare the extracted digital digest with what is being stored in a database associated with the server.

15. The mobile device as recited in claim 14, the identifying pack further includes a number of outlets the merchant has, corresponding locations of the outlets, and/or a corresponding outlet identifier.

16. The mobile device as recited in claim 13, wherein the medium is one or more of a tag and a printed code, a Bluetooth device, a sound, an infrared and iBeacon source.

17. The mobile device as recited in claim 16, further comprising:
reading the tag or the printed code by an Near Field Communication (NFC) interface or a camera.

18. The mobile device as recited in claim 13, wherein the mobile device is installed with a module that is caused to register the mobile device with the server.

19. The mobile device as recited in claim 18, wherein the module installed in the mobile device is configured to access payment applications installed with one or more secure elements in the mobile device, wherein each of the payment applications has been provisioned with an issuing entity.

20. The mobile device as recited in claim 13, wherein the user and the merchant are conducting a transaction over a data network, the module is configured to read either a payment application provisioned with a secure element of the mobile device or an external smart card.
